(19) United States
(12) Patent Application Publication
(10) Pub. No.: US 2021/0339279 A1
(43) Pub. Date: Nov. 4, 2021

(54) SLIP RESISTANT PROTECTIVE COATING FOR SINGLE-PLY MEMBRANES

(71) Applicant: JOHNS MANVILLE, Denver, CO (US)

(72) Inventors: Brenton Yancey, Littleton, CO (US); Jonas Houchin, Centennial, CO (US)

(21) Appl. No.: 16/863,086

(22) Filed: Apr. 30, 2020

(51) Int. Cl. B05D 1/02; B32B 27/32; B32B 27/08; B32B 27/30; E04D 1/20; B05D 1/26; B05D 3/06

(52) U.S. Cl. CPC B05D 1/02; B32B 27/32; B32B 27/08; B32B 27/304; E04D 1/20; B05D 1/265; B32B 2255/26; B32B 2419/06; B32B 2307/71; B32B 2307/7265; B05D 2201/02; B32B 2255/10; B05D 3/067

(57) ABSTRACT

A method of manufacturing a roofing membrane includes providing a waterproof membrane having a top major surface and applying a protective coating directly to the top major surface of the waterproof membrane without the use of an adhesive. The protective coating is configured to be removed from the top major surface.

### BACKGROUND OF THE INVENTION

When installing roofing membranes, it is desirable that workers on a roof can work, safely, and without damaging or discoloring a roofing membrane. However, many factors can create dangerous and/or dirty conditions on the roof. For example, roofing membranes are often smooth and have a high slip potential when wet. If it rains, if there is dew present, and/or if it snows, workers are at a greater risk for slip injuries. Additionally, dirt can be tracked onto the roof from the boots of workers, can be present from the remnants of dust from cutting boards, can be transported by birds and/or other animals, and/or may be present from the removal of a previous roof. If dirt gets onto the roof, time and money are wasted cleaning the newly installed roof. Improvements in the safety and aesthetics of roofing membranes are desired.

### BRIEF SUMMARY OF THE INVENTION

Embodiments of the present direction are directed to roofing membranes that include a waterproofing layer having a removable coating. The removable coating is designed to protect the waterproofing layer from dirt and damage that may occur during installation of the roofing membrane and remaining roof structure. In some embodiments, the coating is also designed to provide anti-slip properties that provide safer surfaces on which workers may walk during the installation process. Once installation is complete, the coating may be removed, thereby exposing a pristine or near-pristine waterproofing layer.

In one particular embodiment, a method of manufacturing a roofing membrane is provided. The method may include providing a waterproof membrane having a top major surface and applying a protective coating directly to the top major surface of the waterproof membrane without the use of an adhesive. The protective coating may be configured to be removed from the top major surface. In some embodiments, applying the protective coating may include spraying the protective coating onto the top major surface of the waterproof membrane. In some embodiments, spraying the protective coating may include applying a first coat and a second coat of the protective coating to the top major surface of the waterproof membrane. In other embodiments, applying the protective coating may involve extruding the protective coating onto the top major surface of the waterproof membrane. In some embodiments, the method may also include curing the protective coating after applying the protective coating. In some embodiments, curing the protective coating may include passing the protective coating under one or both of an infrared light source and an ultraviolet light source. The protective coating may be applied in a liquid form and may include one or more of SBS, SBA, neoprene, ethylene, propylene, rubber, olefin, and vinyl.

In another embodiment, a roofing membrane is provided. The roofing membrane may include a waterproof membrane having a top major surface and a protective coating that is removably applied to the top surface of the waterproof membrane. wherein the protective coating is applied directly to the top major surface without an adhesive. In some embodiments, the protective coating has a thickness of between about 0.002 in. and 0.155 in. In some embodiments, the waterproof membrane may include one or more of TPO, EPDM, and PVC. In some embodiments, the waterproof membrane may include multiple layers. In some embodiments, at least one of the layers of the waterproof membrane includes a reinforcement layer, a fleece layer, or both a reinforcement layer and a fleece layer. In some embodiments, the roofing membrane may have a thickness of between about 0.005 in. and 0.200 in. In some embodiments, the protective coating may be configured to degrade to expose top major surface of the waterproof membrane by exposing the protecting coating to one or both of water and ultraviolet radiation.

In another embodiment, a method of installing a roofing membrane is provided. The method may include positioning a roofing membrane atop an exposed roofing surface. The roofing membrane may include a waterproof membrane having a top major surface and a protective coating that is removably applied to the top surface of the waterproof membrane. The protective coating may be applied directly to the top major surface without an adhesive. The method may also include securing the roofing membrane to the exposed roofing surface and removing the protective coating from the top major surface of the waterproof membrane. In some embodiments, removing the protecting coating may include peeling the protective coating. In other embodiments, removing the protecting coating may include exposing the protective coating to one or both of water and ultraviolet radiation. In some embodiments, the protective coating may have a coefficient of friction of at least 0.6. In some embodiments, the protective coating may have a scratch resistance that is at least 20% greater than a scratch resistance of the top surface of the waterproofing layer. In some embodiments, the protective coating may have a UV resistance of at least 700 kj/m\hat{ }2 @ 340 nm. In some embodiments, the protective coating may have anti-glare properties. Ant-glare tested using ASTM C1549. The coating will reduce reflectivity by at least 20%. For TPO this would be reducing the reflectivity from ˜78% to ˜62%. In some embodiments, the protective coating may have a peel strength of between about 0.2 pli to 200 pli.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a set of parentheses containing a second label that distinguishes among the similar components. If only the first reference label is used in the specification, the description is applicable to any one of the similar components having the same first reference label irrespective of the second reference label.

FIG. 1 illustrates an embodiment of a roofing membrane secured to a roof structure according to embodiments.

FIG. 1A illustrates a perspective view of the roofing membrane of FIG. 1.

FIG. 2 illustrates a roofing membrane having a two layer waterproofing membrane according to embodiments.

FIG. 3 illustrates a roofing membrane having a single layer waterproofing membrane according to embodiments.

FIG. 4 illustrates a spray coating process according to embodiments of the invention.

FIG. 4A illustrates an alternate spray coating process according to embodiments of the invention.

FIG. 5 illustrates an extrusion coating process according to embodiments of the invention.

FIG. 6 is a flowchart of a process for manufacturing a roofing membrane according to embodiments.

FIG. 7 is a flowchart of a process for installing a roofing membrane according to embodiments.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to a protective coating that is applied directly to a top surface of a roofing membrane. As used herein, the term roofing membrane means essentially any material that is installed atop a roof, typically as an outer surface or layer. Such roofing membranes are commonly installed for various functional and/or aesthetic purposes. For example, roofing membranes may be installed to provide weather proofing, reduce urban heat island effects via heat reflection, reduce UV damage, reduce roof maintenance and/or degradation, improving weathering characteristics, and the like. Roofing membranes may also provide a sleek and/or desired roof appearance, such as a uniform roof color and/or style.

In some embodiments, the coating may be applied to the membrane and then actively dried and/or cured, resulting in a protective layer that is removably attached to the membrane. For example, the protective layer may be configured to peel off, be removed by environmental exposure (UV rays, precipitation, etc.), and/or otherwise removed. The coating may be applied to the membrane using any number of techniques such as, but not limited to, spray coating, extrusion, roll coating, and the like. The coating may cover all or a substantial portion of the top surface of the roofing membrane and may help protect the membrane during installation of the roof. Once the roof installation has been completed, the protective coating may be removed, thereby exposing a clean, pristine (or near-pristine) roofing membrane. In some embodiments, the protective coating may also provide various other benefits, such as anti-glare properties and/or slip resistance, which makes walking on the roof safer during and/or after the installation process.

A roofing membrane may be installed with the protective coating still in place, with the protective coating being intended to be removed as a last or nearly last step in the installation of the roofing membrane. The protective coating helps protect the roofing membrane from dirt, scuffs, wear, and/or other events that may be detrimental to the integrity of the roofing membrane. The protective coating may also eliminate the need for expensive and time-consuming cleaning of the newly installed roof. In this manner, the protective coating enables workers permitted to walk on the roof to complete later tasks in a construction process and/or a re-roofing process for a structure without damaging or dirtying the roofing membrane. For example, the worker may seal joints between strips of roofing membrane, seal around any penetrations of the roof, install and connect electrical and/or mechanical equipment on the roof, and/or perform any other tasks. Once such tasks are completed, it is expected that foot traffic on the roof may be negligible. Near the end of the project (or after), the protective coating is removed to expose the top major surface of the roofing membrane, in pristine or near-pristine condition. After removal, the protective coating may be discarded in some embodiments.

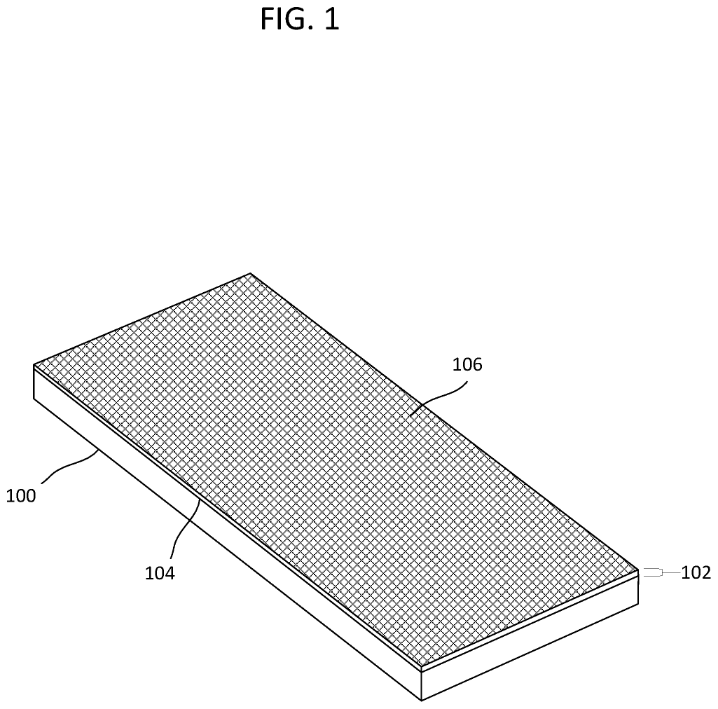

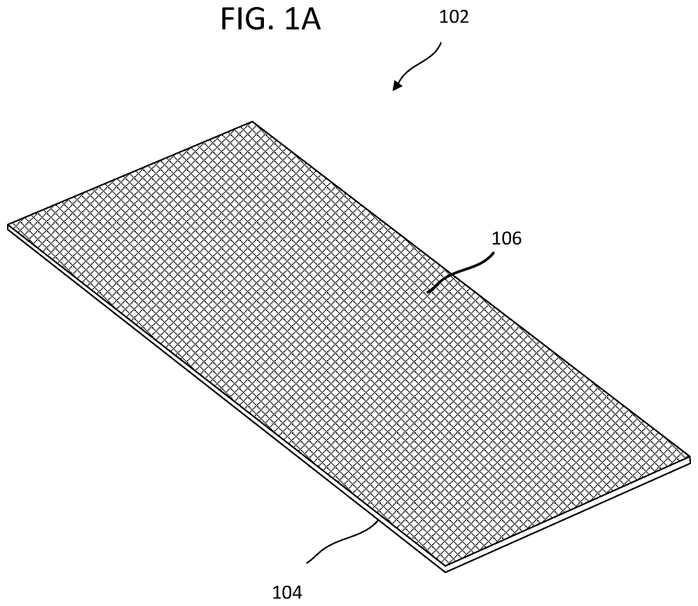

Turning now to FIG. 1, a roof structure 100 that is covered with a roofing membrane 102 is illustrated. The roof structure 100 may be formed atop all or part of a building and/or other structure and may be generally flat and/or pitched. Roof structure 100 may include any number of materials and/or layers in addition to the roofing membrane 102. These layers/materials are typically positioned under the roofing membrane 102 and may include support members (e.g., wood and/or metal beams), insulation layers (e.g., foam and/or other insulating boards), and/or other boards or members. The roofing membrane may be coupled with one or more of these materials via ballasting, mechanical fastening, adhesive bonding, induction welding, heat welding, and the like.

Roofing membrane 102 may be positioned atop roof structure 100, oftentimes above an insulation layer, and may be configured to prevent leaks in the roofing structure 100 and/or to provide aesthetic appeal. Typically, the roofing membrane 102 is in the form of a single ply membrane. The term “single-ply” is used to describe a roof structure 100 having a single application of a roofing membrane 102, but the roofing membrane 102 itself may include multiple layers. For example, the roofing membrane 102 may include polymer layers, reinforcing layers, adhesive layers, coatings, a fleece layer, and the like. It will be appreciated that in some embodiments, multiple layers of roofing membrane 102 may be applied to a single roof structure 100.

Oftentimes, the roofing membrane 102 is provided as a roll of flat, flexible membrane that may be rolled out on top of the roof structure 100. For example, a single ply roofing membrane 102 may be supplied in any workable size (such as, but not limited to, rolls of 10 feet wide or more and containing 100 linear feet or more of roofing membrane 102). Oftentimes, the roof structure 100 is too large to be covered by a single piece of roofing membrane 102. In such instances, multiple pieces of roofing membrane 102 may be overlapped and joined at the seams using a waterproof joining method. For example, seams of adjacent pieces of roofing membrane 102 may be joined by priming and/or preparing edges of the roofing membranes 102 and then applying a tape to the primed and/or prepared edges, using heat welding and/or using another form of adhesive bonding. In priming or preparing the edges, the installer must waft for the primer material to flash before applying the adhesive. Improper application of the primer and/or adhesive may result in an improper bond, which may create immediate and/or long term roofing problems, such as leakage. Examples of using and installing single ply roofing membranes 102 may be found in U.S. Patent Publication No. 2016/0362894, entitled “Sheet Roofing with Pre-Taped Seams and Tape Therefor” and filed Aug. 25, 2016, the entire contents of which is hereby incorporated by reference for all purposes.

In accordance with the present invention, the roofing membrane 102 includes a waterproofing layer 104. The waterproofing layer 104 is configured to form the outer layer of the roof once fully installed, and helps prevent leaks in the roofing structure 100 and provides aesthetic appeal to the finished roof. For example, the waterproofing layer often provides a uniform outer surface that provides an aesthetically pleasing finished appearance to the roof. Waterproofing layer 104 may have a white exterior, but may be made in various other colors or shades, such as grey, tan, black, and the like. White waterproofing layers 104 are often used to provide a pleasing appeal to the building and/or to reflect radiation and thereby minimize heat island effects. In other embodiments, a black or other dark waterproofing layer 102 may be provided. Such waterproofing layers 104 absorb more radiant heat than white waterproofing layers 104. Additionally, in the winter, condensation evaporates quicker and snow and ice melt more rapidly on black roofs than white roofs.

In some embodiments, waterproofing layer 104 may be formed of various synthetic rubber materials, modified bitumen, or thermoplastic materials. For example, roofing membrane 102 may commonly include thermoplastic polyolefin (TPO), polyvinyl chloride (PVC), ethylene propylene diene monomer (EPDM), chlorinated polyethylene (CPA), and/or modified bitumen, although some embodiments may use other thermoset and/or thermoplastic roofing membranes. In some embodiments, the waterproofing layer 104 may include one or more polymers blended with one or more fillers. For example, in some embodiments the waterproofing layer 104 may include some combination of the following materials: polypropylene, polyethylene, block copolymer polypropylene, rubber, plasticizers, fiberglass, carbon fiber, fire retardants, and the like. In another embodiment, a waterproofing layer 104 may have a more pure polymer blend without or with very few fillers. For example, the waterproofing layer 104 may include mainly polypropylene or polyethylene or some combination of these polymers with little to no fillers, although in some embodiments, these waterproofing layer 104 may include some amount of a filler, such as a fire retardant.

When installing the roofing membrane 102, workers must often lay out or otherwise arrange multiple flat sheets of roofing membrane 102 (such as shown in FIG. 1A) to the roof structure 100. The sheets of roofing membrane 102 are then secured to the roof structure 100, such as ballasting, mechanically fastening, adhesive bonding, induction welding, and/or heat welding the pieces of roofing membrane 102 to the roof structure 100. Then the workers must seal any seams formed between adjacent sheets of roofing membrane 102, such as by overlapping the adjacent edges and joining the edges at the seams using a waterproof joining method, such as using heat welding, using primer and tape, and/or other adhesive joining techniques. Additionally, workers must often install and connect electrical and/or mechanical equipment on the roof prior to the completion of the roof installation. Oftentimes, several of these installation steps require the workers to step on at least a portion of the roofing membrane 102, which may track dust and debris on the roofing membrane 102. Additionally, the waterproofing layer 104 is typically slick, especially when wet and/or covered with frost/snow, which may make certain installation procedures that require the workers to traverse the roofing membrane 102 difficult and/or dangerous, especially when installed on a pitched roof. To address these concerns, the roofing membrane 102 includes a temporary protective coating 106 that is applied to the outermost surface of the waterproofing layer 104.

The temporary protective coating 106 may be applied to the waterproof layer 102 prior to installation of the roofing membrane 102, oftentimes during a manufacturing process. The protective coating 106 may provide a tacky and/or higher friction surface that helps workers more safely manage installation tasks that require the worker to walk atop one or more layers of the roofing membrane 102. Additionally, the protective coating 106 may help protect the waterproof layer 104 from any dust, debris, and/or damage that may occur as a result of the installation process. Once the installation process has been completed (or some other point near an end of the installation process), the protective coating 106 may be removed, such as by peeling or otherwise removing the protective coating 106 from the waterproof layer 104, thereby exposing a pristine or near-pristine top surface of the waterproof layer 104. This ensures that the final installed roof will be substantially clean and damage free. While discussed primarily in relation to peel-off protective layers, it will be appreciated that other removal mechanisms may be utilized, such as by using coatings that will automatically degrade upon prolonged exposure to the elements (e.g., precipitation, sunlight, etc.).

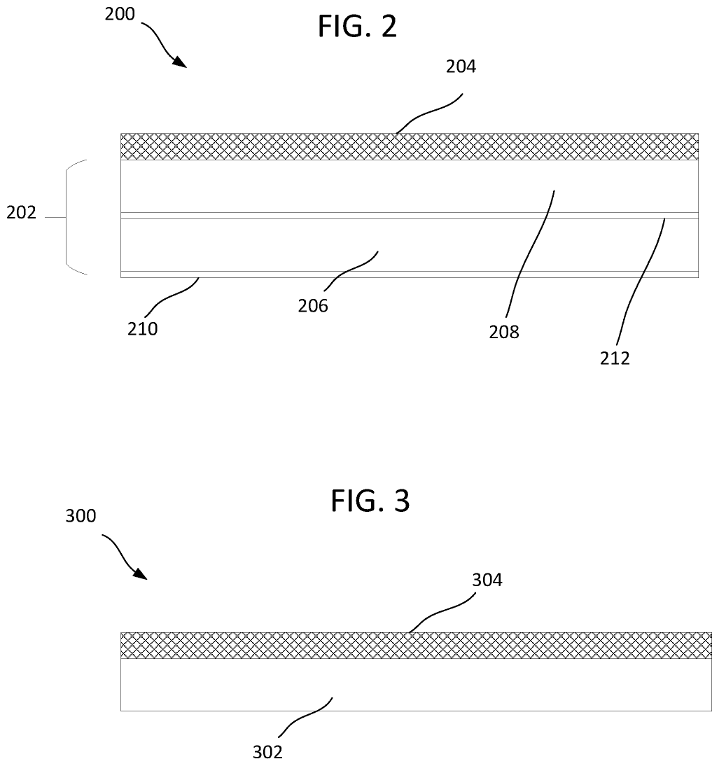

FIG. 2 illustrates one embodiment of a roofing membrane 200. Roofing membrane 200 may be similar to roofing membrane 102 described above, and may include a waterproofing layer 202 and a temporary protective coating 204. As illustrated, the waterproofing layer 202 may be formed of multiple layers. As just one example, the waterproofing layer 202 may be formed from multiple layers of TPO and/or PVC (although other materials, such as EPDM, are possible in some embodiments). For example, a bottom layer 206 may be formed from recycled TPO and/or PVC material, while a top layer 208 may be formed from newly manufactured TOP and/or PVC. It will be appreciated that other materials may be used in some embodiments, and that the bottom layer 206 and top layer 208 need not be the same material in some embodiments. Additionally, the waterproofing layer 202 may include additional layers. As just one example, one or more reinforcement layers, such as a scrim 212, may optionally be provided at the interface between the bottom layer 206 and the top layer 208 and/or at other locations about the waterproofing layer 202. In some embodiments, a fleece layer 210 that may be positioned as a base layer of the waterproofing layer 202. An exposed surface of the top layer 208 may have a uniform and aesthetically pleasing surface that is designed to be exposed after installation on a roof.

The protective coating 204 may be positioned atop and may cover all, or a substantial portion, of an exposed surface of the top layer 208 of the waterproofing layer 202. The protective coating 204 is applied directly to the top layer 208 of the waterproofing layer 202, without any intervening layers or adhesives. The protective coating 204 protects the waterproofing layer 202 from the elements, as well as dirt, debris, and damage associated with the installation of the roofing surface. In some embodiments, the protective coating 204 provides slip resistance to help make the roof installation process safer and more comfortable for workers, especially during application of roofing membrane 200 to a pitched or otherwise sloped roof. The protective coating 204 is applied to the top surface of the top layer 208 in a liquid form, and may be formed of any material that, once cured, provides sufficient peel strength (such as between about 0.2 to 200 pli, 0.2-100 pli, 0.2-50 pli, 0.2-25 pli, 0.2-10 pli, 0.2-5 pli, 0.4-1.5 pli, 0.4-1.0 pli, 0.4-0.8 pli, 0.4-1.2 pli, 0.4-0.6 pli, etc., which may be measured using ASTM D1876), coefficient of friction, and/or anti-slip properties. For example, the cured protective coating may have a kinetic coefficient of friction of at least 0.6, at least 0.7, at least 0.8, at least 0.9, at least 1.0, at least, 1.1, at least 1.2, etc. (in any increments). The protective coating may have a slip-resistance value of at least 40, 45, 50, 55, etc. using a soft rubber slider or at least 45, 50, 55, 60, etc. using a hard rubber slider, which may be tested using test method AS HB198:2014 (AS/NZS 4586) Pendulum Test. The pendulum test is the national standard test device for pedestrian slip resistance in at least 50 nations on five continents and has been endorsed by Ceramic Tile Institute of America since 2001. The pendulum test has been in continuous use since 1970 for assessing slip resistance of pedestrian surfaces and is the most widely accepted slip resistance test device worldwide. The trailing edge of a three-inch-wide spring-loaded slider, which is attached to the end of a 20-inch pendulum, contacts the tested surface when the pendulum is released from a horizontal position. The slider contact path length is pre-set to 124-126 mm (approximately 5 inches). The pendulum pushes a pointer that stops and stays at the high point of the pendulum's swing, resulting in a slip-resistance value.

The protective coating 204 must also forms a peelable and/or biodegradable sheet atop the waterproofing layer 202 once cured. In embodiments in which the protective coating 204 is removed by peeling the protective coating 204 off of a top surface of the top layer 208, the protective coating may have a peel rating of between about 0.2 and 200 pounds per linear inch (oftentimes 0.2-100 pli, 0.2-50 pli, 0.2-25 pli, 0.2-10 pli, 0.2-5 pli, 0.4-1.5 pli, 0.4-1.0 pli, 0.4-0.8 pli, 0.4-1.2 pli, 0.4-0.6 pli, etc), as determined using ASTM D1876. This ensures that the protective coating 204 is sufficiently adhered to the top surface of the top layer 208 so as to not readily fall off, but is also sufficiently easy to peel that a worker may remove the protective coating 204 from the top surface of the top layer 208 by hand, without the use of any tools.

In some embodiments, materials that are useable to produce protective coating 204 having the safety properties above while also providing a peelable and/or biodegradable sheet may include Poly(styrene-butadiene-styrene) (SBS), SBA, neoprene, ethylene, propylene, rubber, olefin, styrene, butadiene, and/or vinyl. In one particular embodiment, the protective coating 204 may include a Plasti Dip® rubber coating available from Plasti Dip International of Blaine, Minn., USA. In some embodiments, the protective coating 204 may be provided as a black and/or otherwise dark material, which may be particular beneficial in the winter, as the dark protective coating 204 may help evaporate condensation quicker and help snow and ice melt more rapidly than lighter protective coatings, thereby making the roofing membrane 200 easier and safer to walk on under such conditions.

The protective coating 204 additionally provides damage resistance to the roofing membrane 200, ensuring that upon completion of the installation process the waterproofing layer 202 is in pristine and/or near-pristine condition. To achieve these results, the protective coating 204 may possess a scratch resistance that is at least 20% greater than a scratch resistance of the waterproofing layer 202 as determined by ASTM D7027, a heat resistance that reduces the charred and/or melted portion of the waterproofing layer 202 by 10% as measured by ASTM D2859, and/or abrasion resistance measured by ASTM D3389, that maintains a weight loss of the waterproofing layer 202 is reduced to approximately 0 g. In other words, the protective coating 204 can have weight loss, but the protective coating 204 will protect the waterproofing layer 202 such that the waterproofing layer 202 will not face any noticeable weight loss during the test.

In some embodiments, the protective coating 204 provides additional properties to the roofing membrane 200 during the installation process. For example, the protective coating 204 may have anti-glare properties that make it easier for workers to look at and work on the roofing membrane 200 during various tasks during installation of the roof. The anti-glare properties of the protective coating 204 are measured using ASTM C1549, and may reduce reflectivity of the roofing membrane 200 by at least 20%. For example, with a waterproofing layer 202 of TPO (having a reflectivity of ˜78%), the protective coating 204 reducing the reflectivity to ˜62%. In some embodiments, the protective coating 204 may also provide UV protection to the underlying waterproofing layer 202. For example, the protective coating 204 may exhibit UV resistance of at least 700 kj/m\hat{ }2 @ 340 nm (which is the equivalent to 90 days of UV exposure in Florida), which may be tested using ASTM G155/D6878. In some embodiments, additionally properties, such as fire retardance, may also be provided by the protective coating 204, oftentimes through the use of additives.

In some embodiments, the roofing membrane 200 may have a total thickness of between about 0.030 in. and 0.200 in., and more commonly between about 0.045 in. and 0.150 in. The thickness of the waterproofing layer 202 may be between about 0.028 in. and 0.198 in., with thicknesses of between about 0.045 in. and 0.090 being most common. In some embodiments, each of the top layer 208 and the bottom layer 206 may have approximately the same thickness. For example, each of the top layer 208 and the bottom layer 206 may have a thickness of between about 0.014 in. and 0.099 in., more commonly between about 0.0225 in. and 0.045 in. In other embodiments, the top layer 208 and the bottom layer 206 may have different thicknesses. For example, one of the top layer 208 and the bottom layer 206 may have a thickness of between about 0.007 in. and 0.099 in. while the other layer has a thickness of between about 0.021 in. and 0.191 in. It will be appreciated that in embodiments in which additional layers, such as reinforcement layers, are provided, the thickness of one or both of the top layer 208 and the bottom layer 206 may be adjusted to accommodate the additional layer(s) within the total thickness of the waterproofing layer 202. A thickness of the protective coating 204 may be between about 0.002 in. and 0.155 in, more commonly between about 0.005 in. and 0.100 in., and even more commonly between about 0.005 in. and 0.050 in or between about 0.010 in. and 0.030 in.

FIG. 3 illustrates another embodiment of a roofing membrane 300. Roofing membrane 300 may be similar to roofing membrane 102 and 200 described above, and may include a waterproofing layer 302 and a temporary protective coating 304. In contrast to roofing membrane 200, the waterproofing layer 302 of roofing membrane 300 is formed of a single layer. As just one example, the waterproofing layer 302 may be formed from a single layer of EPDM (although other materials, such as TPO and/or PVC, are possible in some embodiments). The waterproofing layer 302 may be monolithic, with only a single chemistry present throughout the waterproofing layer 302. An exposed surface of the top layer waterproofing layer 302 may have a uniform and aesthetically pleasing surface that is designed to be exposed after installation on a roof.

The protective coating 304 may be positioned atop and may cover all, or a substantial portion, of an exposed surface of the waterproofing layer 302. The protective coating 304 is applied directly to the exposed top surface of the waterproofing layer 302, without any intervening layers or adhesives. The protective coating 304 may be the same or similar to protective coating 204 described above, and may protect the waterproofing layer 302 from the elements, as well as dirt, debris, and damage associated with the installation of the roofing surface. In some embodiments, the protective coating 304 provides slip resistance damage resistance, UV protection, and/or anti-glare properties to the roofing membrane 300. The protective coating 304 is applied to the top surface of the top layer 308 in a liquid form, and may be formed of any material that, once cured, provides sufficient tackiness, coefficient of friction, and/or anti-slip properties. The protective coating 304 must also forms a peelable and/or biodegradable sheet atop the waterproofing layer 302 once cured.

In some embodiments, the roofing membrane 300 may have a total thickness of between about 0.030 in. and 0.200 in., and more commonly between about 0.045 in. and 0.150 in. The thickness of the waterproofing layer 202 may be between about 0.028 in. and 0.198 in., with thicknesses of between about 0.045 in. and 0.090 being most common. A thickness of the protective coating 304 may be between about 0.002 in. and 0.155 in, more commonly between about 0.005 in. and 0.100 in., and even more commonly between about 0.005 in. and 0.050 in or between about 0.010 in. and 0.030 in.

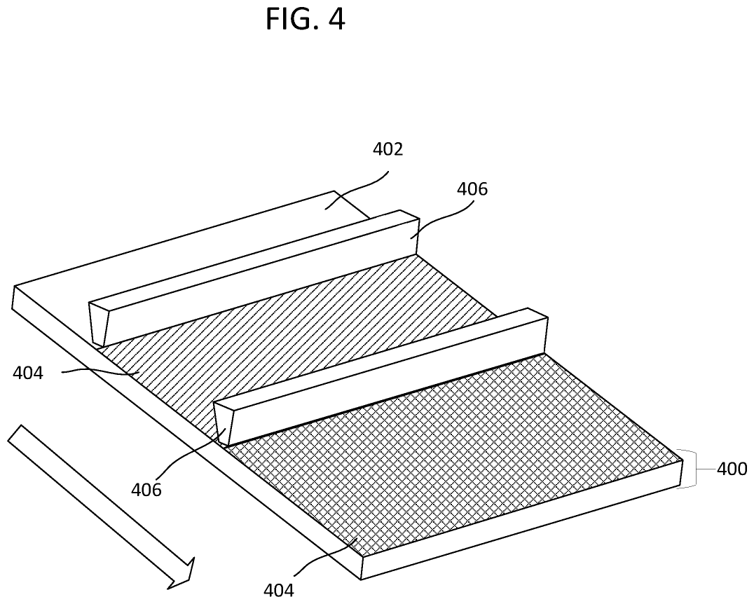

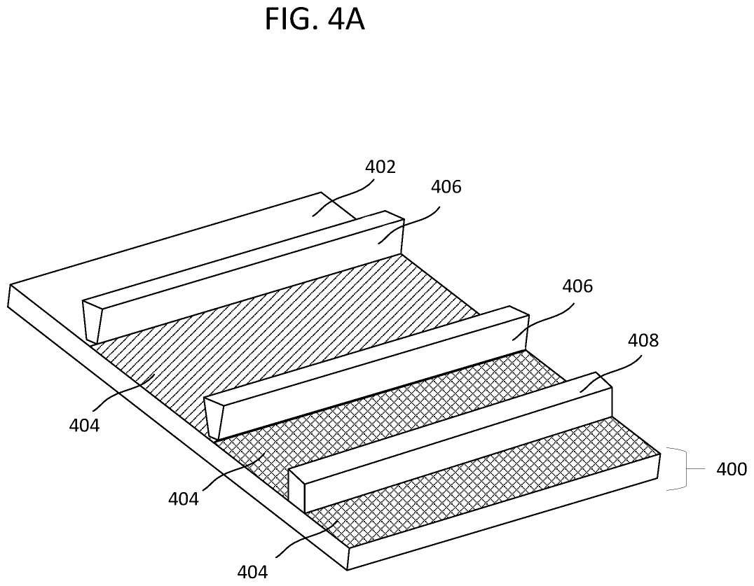

FIG. 4 illustrates one process of manufacturing a roofing membrane 400. The roofing membrane 400 may be similar to any of the roofing membranes 102, 200, 300 described above. As illustrated, a waterproofing layer 402 may be provided. The waterproof membrane 402 may be similar to those described elsewhere herein, and may be passed under one or more spray heads 406. Spray heads 406 apply a liquid form of a protective coating 404, which may be similar to the protective coatings described elsewhere herein, directly to a top surface of the waterproofing layer 402, without any intervening layers or adhesives. In some embodiments, a single set of spray head 406 may be sufficient to apply a coating of between about 0.002 in. and 0.155 in, more commonly between about 0.005 in. and 0.100 in., and even more commonly between about 0.005 in. and 0.050 in. or about 0.010 in. and 0.030 in. thick atop the waterproofing layer 402. In other embodiments, multiple sets of spray heads 406 may be needed to provide one or more coats of the liquid protective coating 404 to ensure that the protective coating is sufficiently thick atop the waterproofing layer. In some embodiments, once applied, the liquid protective coating 404 may be dried and/or cured by exposure to air. In other embodiments, additional drying and/or curing steps may be provided.

For example, as illustrated in FIG. 4A, once a sufficient coating of the liquid protective coating 404 has been applied to the waterproofing layer 402, the waterproofing layer 402 and protective coating 404 are passed under light source 408. Light source 408 may emit IR light and/or UV light to cure the protective coating 404 atop the waterproofing layer 402. In some embodiments, the protective coating 404 may be cured using heat and/or circulating air. For example, the waterproofing layer 402 and protective coating 404 may be passed through an oven and/or under fans to help cure the protective coating 404. Once cured, the protective coating 404 provides a peelable and/or otherwise removable coating over the waterproofing layer 402 as explained herein.

In some embodiments, the waterproofing layer 402 may be pre-formed and subjected to the spray coating process as a later step prior to shipment and/or installation. In other embodiments, the spray coating process described above may be in-line of the manufacturing process of the waterproofing layer 402 and may be considered as a finishing process. Upon completion of the formation of the roofing membrane 400, the roofing membrane 400 may be cut to desired dimensions and/or be wound onto a roll for subsequent storage and/or shipment.

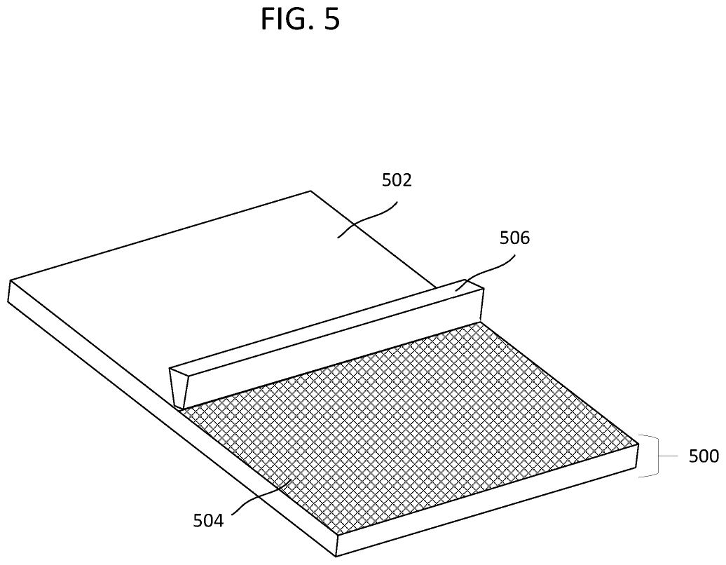

FIG. 5 illustrates an alternative process for manufacturing a roofing membrane 500. The roofing membrane 500 may be similar to any of the roofing membranes 102, 200, 300 described above. As illustrated, a waterproofing layer 502 may be provided. The waterproof membrane 502 may be similar to those described elsewhere herein, and may be passed under an extrusion die 506. A liquid form of a protective coating 504, which may be similar to the protective coatings described elsewhere herein, may be pumped to the extrusion die 506. The extrusion die 506 then extrudes the protective coating 504 directly to a top surface of the waterproofing layer 502, without any intervening layers or adhesives. The extrusion die 506 may be configured to extrude a layer of protective coating 506 that has a thickness of between about 0.002 in. and 0.155 in, more commonly between about 0.005 in. and 0.100 in., and even more commonly between about 0.005 in. and 0.050 in. or about 0.010 in. and 0.030 in. atop the waterproofing layer 402.

In some embodiments, once applied, the liquid protective coating 504 may be dried and/or cured by exposure to air. In other embodiments, additional drying and/or curing steps may be provided. For example, once a sufficient coating of the liquid protective coating 504 has been extruded onto the waterproofing layer 502, the waterproofing layer 502 and protective coating 504 may be exposed to IR light, UV light, heat, and/or circulating air to cure the protective coating 504. Once cured, the protective coating 504 provides a peelable and/or otherwise removable coating over the waterproofing layer 502 as explained herein.

In some embodiments, the waterproofing layer 502 may be pre-formed and subjected to the extrusion process as a later step prior to shipment and/or installation. In other embodiments, the extrusion die 506 may be in-line of the manufacturing process of the waterproofing layer 502 and may be considered as a finishing process. Upon completion of the formation of the roofing membrane 500, the roofing membrane 500 may be cut to desired dimensions and/or be wound onto a roll for subsequent storage and/or shipment.

It will be appreciated that the manufacturing processes described above merely represent examples of manufacturing/coating processes and that other embodiments may form a roofing membrane using other known techniques. For example, the protective coatings described herein may be applied to a waterproofing layer using roller coating techniques. In other embodiments, the protective coating may be poured onto the waterproofing layer and uniformly spread to a desired thickness using a spreader bar. It will be appreciated that other coating techniques are possible.

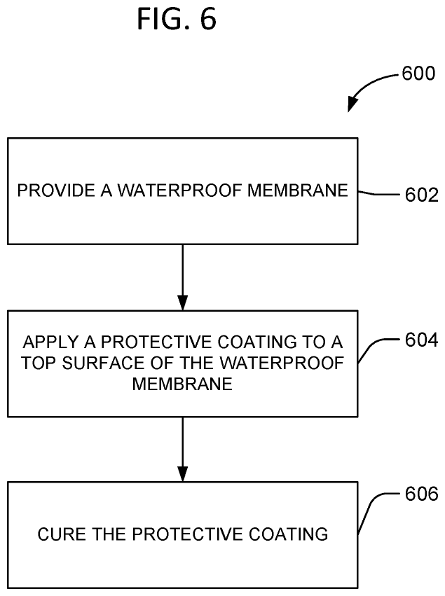

FIG. 6 is a flowchart of a process 600 for manufacturing a roofing membrane. Process 600 may be used to produce any of the roofing membranes described herein, including roofing membranes 102, 200, and 300. Process 600 may begin at block 602 by providing a waterproof layer or membrane having a top major surface. The waterproof membrane may be similar to waterproofing layers 104, 202, and 302 described herein, and may be formed from TPO, EPDM, PVC, and/or other waterproofing materials. At block 604, a protective coating may be applied directly to the top major surface of the waterproof membrane without the use of an adhesive. The protective coating may be applied in a liquid form and may include SBS, SBA, neoprene, ethylene, propylene, rubber, olefin, and/or vinyl. In some embodiments, to apply the protective coating, the protective coating may be pumped and/or otherwise supplied to one or more spray heads (such as spray heads 406) that then spray the protective coating onto the top major surface of the waterproof membrane. In some embodiments, multiple coats of the protective coating may be sprayed on top of the waterproof membrane. In other embodiments, the protective coating may be applied by passing the waterproof membrane under an extrusion die (such as extrusion die 506). The protective coating may be pumped to the extrusion die in liquid form and then may be applied to the top surface of the waterproof membrane. In yet other embodiments, the protective coating may be applied by roller coating and/or spreading the coating atop the waterproof membrane.

In some embodiments, the process 600 may also include curing the protective coating at block 604. To cure the protective coating, the protective coating may be passively cured by subjecting the protective coating to prolonged exposure to the air. In other embodiments, the protective coating may be actively cured, such as by exposing the protective coating to IR light, UV light, heat, and/or circulating air. Once cured, the protective coating is configured to be removed from the top major surface, such as by peeling and/or biodegrading.

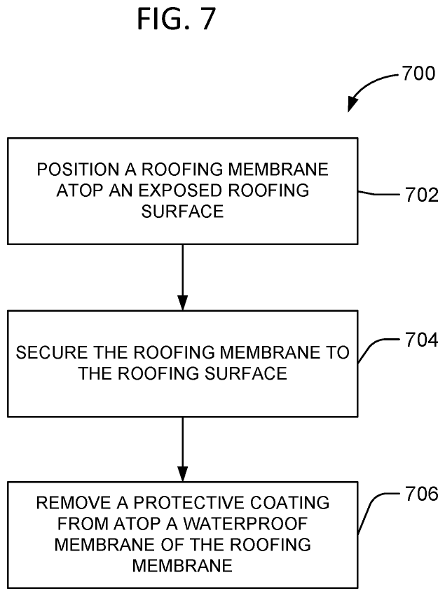

FIG. 7 is a flowchart illustrating a process 700 for installing a roofing membrane. Process 700 may use any of the roofing membranes described herein, including roofing membranes 102, 200, and 300. Process 700 may begin at block 702 by positioning a roofing membrane atop an exposed roofing surface. As described herein, the roofing membrane may include a waterproof membrane having a top major surface and a protective coating that is removably applied to the top surface of the waterproof membrane, with the protective coating being applied directly to the top major surface without an adhesive. At block 704, the roofing membrane is secured to the exposed roofing surface. In some embodiments, this may involve applying an adhesive between the exposed roofing surface and an underside of the waterproof membrane. In some embodiments, in addition to, or in place of, the adhesive, ballasting, mechanical fastening, induction welding, and/or heat welding may be used to secure the roofing membrane to the exposed roofing surface. Oftentimes, multiple pieces of roofing membrane may be needed to cover all or substantially all of the exposed roofing surface. In such embodiments, the edges of the pieces of roofing membrane may be joined together and waterproofed. For example, multiple pieces of roofing membrane may be overlapped and joined at the seams using a waterproof joining method. In some embodiments, this may involve joining seams of adjacent pieces of roofing membrane by priming and/or preparing edges of the roofing membranes and then applying a tape to the primed and/or prepared edges. In other embodiments, the edges of the roofing membrane may be joined using heat welding, induction welding, and/or using another form of adhesive bonding.

Once the roofing membrane has been secured, sealed, and/or any other installation processes have been completed (such as installing or servicing any electrical and/or mechanical equipment on the roof), the protective coating may be removed from the top major surface of the waterproof membrane at block 706. In some embodiments, the protective coating may be removed by peeling the protective coating from the top surface of the waterproof membrane. This may be done by hand in some embodiments. In other embodiments, the protective coating may be removed by prolonged exposure to the elements. For example, the protective coating may be formed of biodegradable materials that degrade when subject to prolonged exposure to water, UV radiation, etc.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. It will be further appreciated that all testing methods described here may be based on the testing standards in use at the time of filing or those developed after filing.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A method of manufacturing a roofing membrane, the method comprising:
providing a waterproof membrane having a top major surface; and
applying a protective coating directly to the top major surface of the waterproof membrane without the use of an adhesive, wherein the protective coating is configured to be removed from the top major surface.

2. The method of manufacturing a roofing membrane of claim 1, wherein:
applying the protective coating comprises spraying the protective coating onto the top major surface of the waterproof membrane.

3. The method of manufacturing a roofing membrane of claim 2, wherein:
spraying the protective coating comprises applying a first coat and a second coat of the protective coating to the top major surface of the waterproof membrane.

4. The method of manufacturing a roofing membrane of claim 1, wherein:
applying the protective coating comprises extruding the protective coating onto the top major surface of the waterproof membrane.

5. The method of manufacturing a roofing membrane of claim 1, further comprising:
curing the protective coating after applying the protective coating.

6. The method of manufacturing a roofing membrane of claim 5, further comprising:
curing the protective coating comprises passing the protective coating under one or both of an infrared light source and an ultraviolet light source.

7. The method of manufacturing a roofing membrane of claim 5, further comprising:
curing the protective coating comprises passing the protective coating past one or both of a heat source and a source of circulating airflow.

8. The method of manufacturing a roofing membrane of claim 1, wherein:
the protective coating is applied in a liquid form and comprises one or more of SBS, SBA, neoprene, ethylene, propylene, rubber, olefin, and vinyl.

9. A roofing membrane, comprising:
a waterproof membrane having a top major surface; and
a protective coating that is removably applied to the top surface of the waterproof membrane, wherein the protective coating is applied directly to the top major surface without an adhesive.

10. The roofing membrane of claim 9, wherein:
the protective coating has a thickness of between about 0.002 in. and 0.155 in.

11. The roofing membrane of claim 9, wherein:
the waterproof membrane comprises one or more of TPO, EPDM, modified bitumen, and PVC.

12. The roofing membrane of claim 9, wherein:
the waterproof membrane comprises multiple layers.

13. The roofing membrane of claim 12, wherein:
at least one of the layers of the waterproof membrane comprises a reinforcement layer.

14. The roofing membrane of claim 9, wherein:
the roofing membrane has a thickness of between about 0.005 in. and 0.200 in.

15. The roofing membrane of claim 9, wherein:
the protective coating is configured to degrade to expose top major surface of the waterproof membrane by exposing the protecting coating to one or both of water and ultraviolet radiation.

16. A method of installing a roofing membrane, comprising:
positioning a roofing membrane atop an exposed roofing surface, the roofing membrane comprising:
a waterproof membrane having a top major surface; and
a protective coating that is removably applied to the top surface of the waterproof membrane, wherein the protective coating is applied directly to the top major surface without an adhesive;
securing the roofing membrane to the exposed roofing surface; and
removing the protective coating from the top major surface of the waterproof membrane.

17. The method of installing a roofing membrane of claim 16, wherein:
removing the protecting coating comprises peeling the protective coating.

18. The method of installing a roofing membrane of claim 16, wherein:
removing the protecting coating comprises exposing the protective coating to one or both of water and ultraviolet radiation.

19. The method of installing a roofing membrane of claim 16, wherein:
the protective coating has a coefficient of friction of at least 0.6.

20. The method of installing a roofing membrane of claim 16, wherein:
the protective coating has a scratch resistance that is at least 20% greater than a scratch resistance of the waterproofing layer.

21. The method of installing a roofing membrane of claim 16, wherein:
the protective coating has a UV resistance of at least 700 kj/m\hat{ }2 @ 340 nm.

22. The method of installing a roofing membrane of claim 16, wherein:
the protective coating reduces reflectivity by at least 20% relative to the waterproofing layer.

23. The method of installing a roofing membrane of claim 16, wherein:
the protective coating has a peel strength of between about 0.2 pli to 200 pli.
